(19) United States
(12) Patent Application Publication
(10) Pub. No.: US 2019/0163663 A1
(43) Pub. Date: May 30, 2019

(54) COMMUNICATION CONTROLLER, COMMUNICATION METHOD, AND SYSTEM ON A CHIP

(71) Applicant: Shanghai Zhaoxin Semiconductor Co., Ltd., Shanghai (CN)

(72) Inventors: Xianpei ZHENG, Beijing (CN); Yang SHI, Beijing (CN); Zhongmin CHEN, Beijing (CN); Wei-Lin WANG, Beijing (CN); Jiin LAI, New Taipei City (TW)

(21) Appl. No.: 16/114,726

(22) Filed: Aug. 28, 2018

(30) Foreign Application Priority Data
Nov. 27, 2017 (CN) 201711205223.1

(51) Int. Cl. G06F 15/173; G06F 15/78; G06F 15/82

(52) U.S. Cl. CPC G06F 15/17306; G06F 15/82; G06F 15/7807

(57) ABSTRACT

An optimized communication technique is provided. A transaction capability table records a first value representing practical transaction capability of a source module for transmitting a communication transaction to a destination module. Exchange of transaction capability regarding the destination module between the source module and at least one neighboring source module is taken into account in the first value. The source control logic circuit manages the transaction capability table and controls the source module to transmit a communication transaction to the destination module based on the first value recorded in the transaction capability table.

### CROSS REFERENCE TO RELATED APPLICATIONS

This Application claims priority of China Patent Application No. 201711205223.1, filed on Nov. 27, 2017, the entirety of which is incorporated by reference herein.

### BACKGROUND OF THE INVENTION

### Field of the Invention

The present invention relates to signal communication.

### Description of the Related Art

Communication between different devices/functional blocks is an issue that has received a lot of focus in the electronic design field.

With the development of SoC (System on a Chip) technology, the communication control for SoC has come to involve an on-chip interconnection network in the SoC. Fluent communication between different devices/functional blocks (or IPs) in SoC is an important part of the overall design.

### BRIEF SUMMARY OF THE INVENTION

Communication between devices/functional blocks is optimized.

A communication controller in accordance with an exemplary embodiment of the disclosure has a transaction capability table and a source control logic circuit. The transaction capability table records a first value representing the practical transaction capability of a source module for transmitting a communication transaction to a destination module. The exchange of transaction capability, regarding the destination module, between the source module and at least one neighboring source module is taken into account in the first value. The source control logic circuit manages the transaction capability table and controls the source module to transmit a communication transaction to the destination module based on the first value recorded in the transaction capability table.

In an exemplary embodiment, the transaction capability table further records a second value and a third value. The second value represents borrowed transaction capability that the source module borrows from the neighboring source module for transmitting a communication transaction to the destination module. The third value represents a loan of transaction capability that the source module lends to the neighboring source module to transmit a communication transaction to the destination module. The transaction capability table may further record borrowing information and loan information. The borrowing information lists neighboring source modules from which the source module receives the borrowed transaction capability. The loan information lists neighboring source modules that receive the loan of transaction capability.

A system on a chip in accordance with an exemplary embodiment of the disclosure has a plurality of source modules and at least one destination module. Each source module has one of the aforementioned communication controllers to transmit at least one communication transaction to the destination module.

A communication method in accordance with an exemplary embodiment of the disclosure includes the following steps: using a transaction capability table to record a first value representing practical transaction capability of a source module for transmitting a communication transaction to a destination module, wherein exchange of transaction capability regarding the destination module between the source module and at least one neighboring source module is taken into account in the first value; and managing the transaction capability table and controlling the source module to transmit a communication transaction to the destination module based on the first value recorded in the transaction capability table.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a system on a chip (SoC) 100, having an on-chip interconnection network 102;

FIG. 2 depicts an architecture for communication from a functional block P0 to another functional block P1 on the SoC 100;

FIG. 3 depicts the modifications made to a source module for communication optimization in accordance with an exemplary embodiment of the disclosure;

FIGS. 4A, 4B, and 4C depict a flowchart illustrating the management of the transaction capability tables Tab₀ . . . Tab₍ₘ₋₁₎ in accordance with an embodiment of the disclosure;

FIG. 5 illustrates the optimized communication technology implemented on the side of destination modules in accordance with an exemplary embodiment of the disclosure;

FIG. 6 is a flowchart illustrating the use of the turbo queues of FIG. 5 in accordance with an exemplary embodiment of the disclosure;

FIG. 7 is another flowchart illustrating the use of the turbo queues of FIG. 5 in accordance with an exemplary embodiment of the disclosure;

FIG. 8 illustrates an optimized communication technology implemented on the side of destination modules in accordance with another exemplary embodiment of the disclosure;

FIG. 9 illustrates how communication transactions transmitted to a destination module Tₖ through the on-chip interconnection network 102 is filled in a turbo queue taught in FIG. 8;

FIG. 10 is a flowchart illustrating the use of the turbo queues of FIG. 8 in accordance with an exemplary embodiment of the disclosure;

FIG. 11A is a flowchart illustrating the use of the turbo queues of FIG. 8 in accordance with an embodiment of the disclosure;

FIG. 11B is another flowchart illustrating the use of the turbo queues of FIG. 8 in accordance with an embodiment of the disclosure; and

FIG. 12 is a block diagram depicting communication optimization in accordance with an exemplary embodiment of the disclosure.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

The communication technology described in this disclosure may be applied to various architectures of electronic systems. In the following, an on-chip interconnection network in SoC (System on a Chip) is discussed as an example, but it is not intended to be limited thereto.

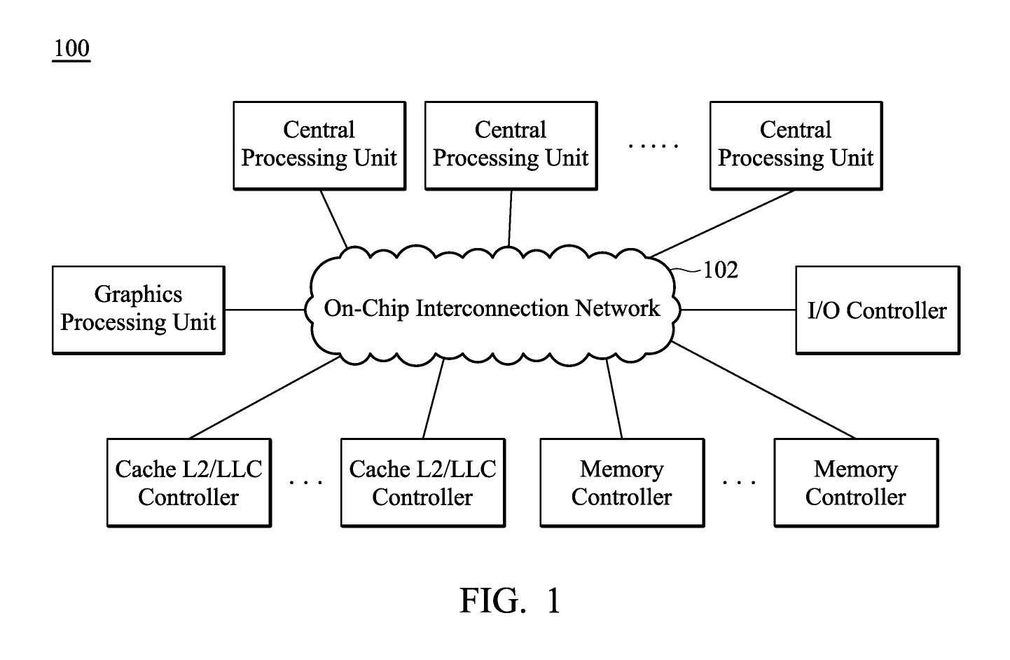

FIG. 1 depicts a system on a chip (SoC) 100, having an on-chip interconnection network 102. The on-chip interconnection network 102 is a communication bridge between devices/functional blocks (or IPs) in SoC. As shown, the devices/functional blocks (or IPs) may include a central processing unit (CPU), an image processor (GPU), an input/output controller (I/O controller), a cache L2/LLC controller and a memory controller.

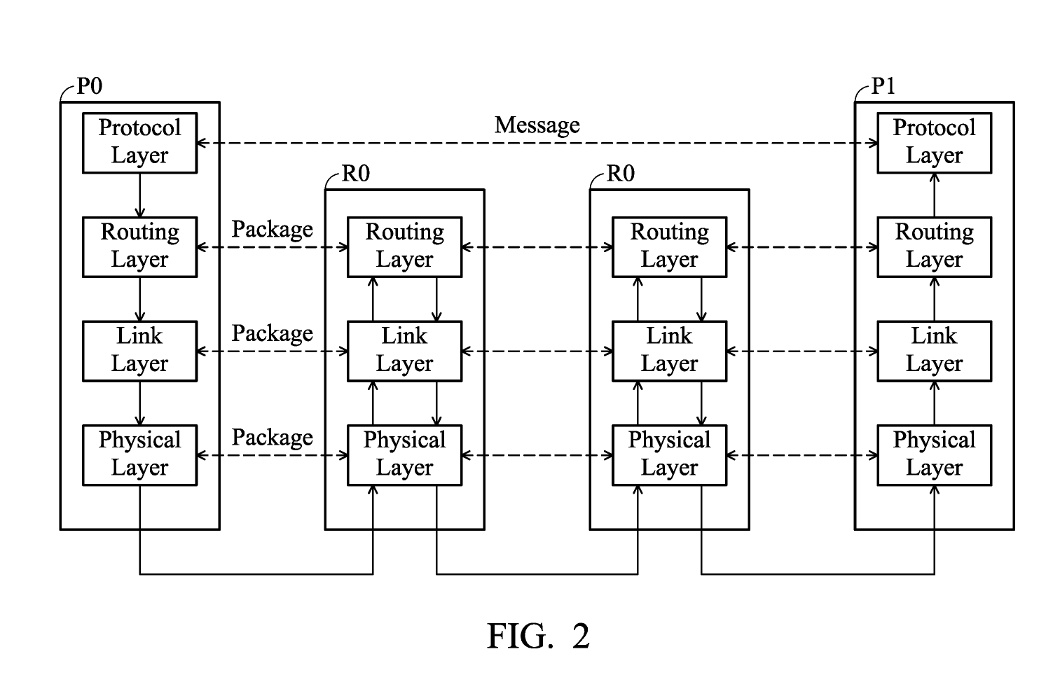

FIG. 2 depicts an architecture for communication from a functional block P0 to another functional block P1 on the SoC 100. The switches/routers RO are provided for signal transmission. The switches/routers RO form the aforementioned on-chip interconnection network 102. Signals are transmitted by packages through an architecture that includes a routing layer, a link layer, and a physical layer. Signals are transmitted as messages through a protocol layer. In the disclosure, the protocol layer is specially designed to make the point-to-point communication between different functional blocks smooth. The computing hardware and code involved in the technology of the present disclosure may be implemented as a single hardware module, or embedded in a microcontroller of a functional block, or placed in a link interface of a functional block. In an exemplary embodiment, a specially-designed state machine is provided in the protocol layer to implement the disclosure.

The functional blocks in the SoC 100 sometimes act as a source of communication data, sometimes as a destination for communication data. For example, a central processing unit may be a source module that provides data to be transmitted to the cache L2/LLC controller via the on-chip interconnection network 102. The central processing unit may also be a destination module that receives the data that the memory controller read from a memory. Communication optimization may be applied to modify a source module or a destination module. The functional blocks that switch between the two roles (sometimes being a source module and sometimes being a destination module) may combine the two types of communication optimization solutions.

First, the modifications made to the source module for communication optimization are discussed.

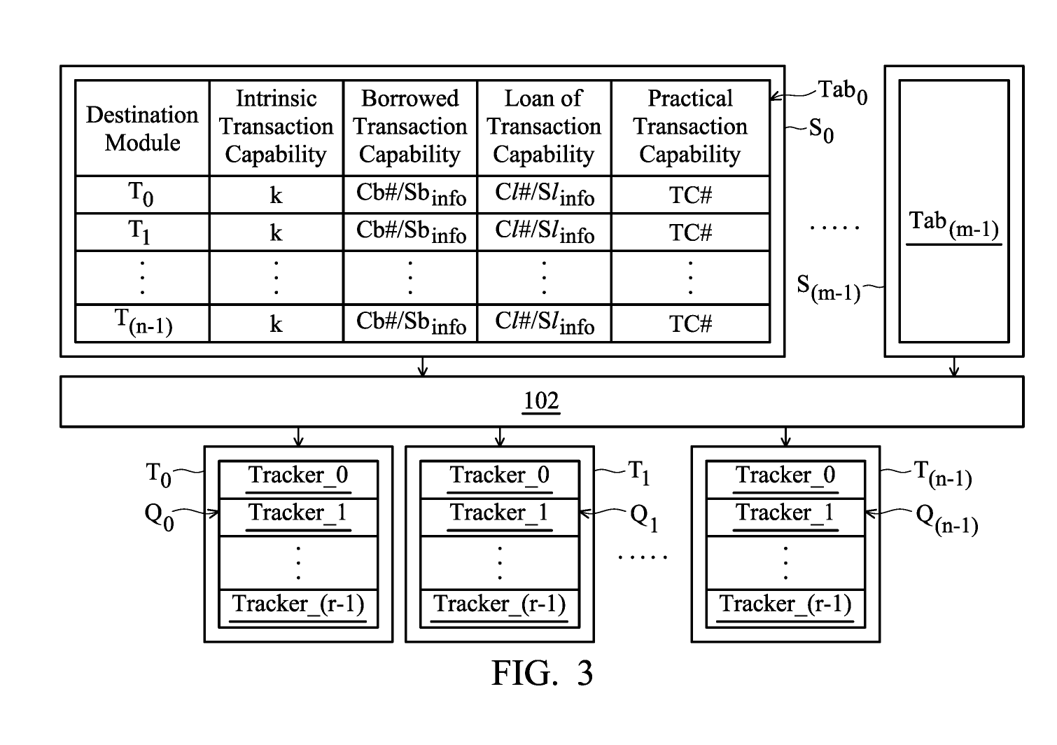

FIG. 3 depicts the modifications made to the source module for communication optimization in accordance with an exemplary embodiment of the disclosure. The source modules S₀ . . . S₍ₘ₋₁₎ may request communication transactions to the destination modules T₁ . . . T₍ₙ₋₁₎ via the intra-chip interconnect network 102. The source modules S₀ . . . S₍ₘ₋₁₎ may exchange transaction capability (or credits for transmitting communication transactions). As shown, transaction capability tables Tab₀ . . . Tab₍ₘ₋₁₎ are managed on the source modules S₀ . . . S₍ₘ₋₁₎, respectively, as a reference for the source modules S₀ . . . S₍ₘ₋₁₎ to transmit communication transactions to the destination modules T₀ . . . T₍ₙ₋₁₎. In this embodiment, there are n queues Q₀, Q₁ . . . Q₍ₙ₋₁₎ provided in the n destination modules T₀, T₁ . . . T₍ₙ₋₁₎, respectively. Each of the queues Q₀, Q₁ . . . Q₍ₙ₋₁₎ provides r trackers Tracker_0, Tracker_1 . . . Tracker_(r−1) for temporary storage and dynamic management of communication transactions requested by the source modules S₀ . . . S₍ₘ₋₁₎. Each tracker is provided to track one communication transaction. Each tracker has a state machine that dynamically manages the tracked communication transaction.

The transaction capability table Tab₀ is discussed in this paragraph as an example. In the transaction capability table Tab₀, several factors are recorded for each of the destination modules T₀ . . . T₍ₙ₋₁₎. The factors include values representing intrinsic transaction capability k, borrowed transaction capability Cb#, a loan Cl# of transaction capability, and practical transaction capability TC#. The practical transaction capability TC# is estimated from the intrinsic transaction capability k, the borrowed transaction capability Cb#, the loan Cl# of transaction capability and transaction capability consumption C#. Based on the practical transaction capability TC#, it is determined whether the corresponding source module could transmit a communication transaction to the corresponding destination module without affecting the communication network. The non-zero value of the practical transaction capability TC# represents that the corresponding source module is allowed to issue a communication transaction to the corresponding destination module. When the practical transaction capability TC# is zero, the source module is not allowed to request a communication transaction to the destination module to avoid blocking the communication network.

In this paragraph, the contents recorded in the transaction capability table Tab₀ for the destination modules T₀ is discussed in detail. The intrinsic transaction capability k may be r/m. The number of trackers Tracker_0, Tracker_1 . . . Tracker_(r−1) contained in the queue Q₀ is r, which is expected to be evenly shared by the m source modules S₀ . . . . The borrowed transaction capability Cb# shows how much transaction capacity the source module S₀ has borrowed from other source modules S₁ . . . S₍ₘ₋₁₎ to transmit communication transactions to the destination module T₀. In an exemplary embodiment, borrowing information Sb_{info} is recorded to show which source modules the borrowed transaction capability Cb# comes from. The loan Cl# of transaction capability shows how much transaction capacity the source module S₀ lends other source modules S₁ . . . S₍ₘ₋₁₎ to transmit communication transactions with the destination module T₀. In an exemplary embodiment, loan information Sl_{info} is recorded which lists the source modules that get the loan Cl# of transaction capability. The transaction capability consumption C# reflects the number of communication transactions that have been transmitted from the source module S₀ to the destination module T₀ and is being processed in the destination module T₀. When one communication transaction requested by the source module S₀ is stored to the queue Q₀ of the destination module T₀, the value representing the transaction capability consumption C# is increased by one. After a communication transaction is finished and removed from the queue Q₀, the value representing the transaction capability consumption C# is decreased by 1. An estimate of the practical transaction capability TC# of the source module S₀ to request communication transaction to the destination module T₀ can be calculated using the following formula:

TC#=k+Cb#−Cl#−C#

By sharing the transaction capability regarding a particular destination module between the different source modules, the practical transaction capability TC# can be kept above zero. As a result, the source module S₀ is no longer limited to the intrinsic transaction capability k if it has a strong communication transaction demand to the destination module T₀. On the contrary, if the source module S₀ does not have a demand for communication transactions to the destination module T₀, its intrinsic transaction capability k can be lent to the other source modules S₁ . . . In one exemplary embodiment, the loan Cl# of transaction capacity cannot exceed the intrinsic transaction capability k. Only the intrinsic transaction capability k can be loaned.

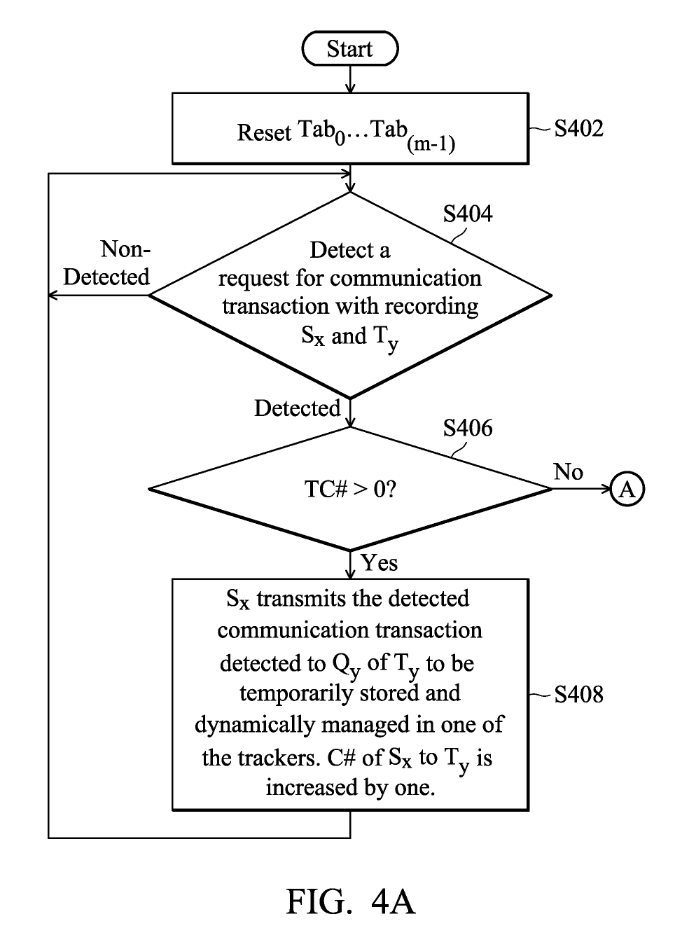

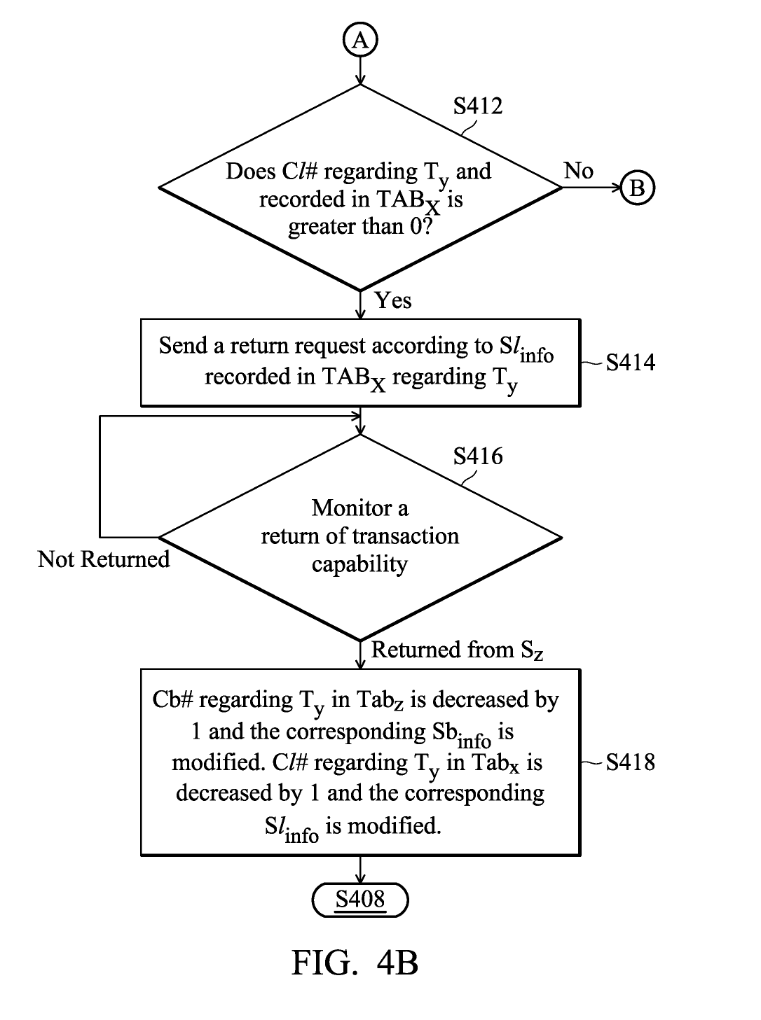

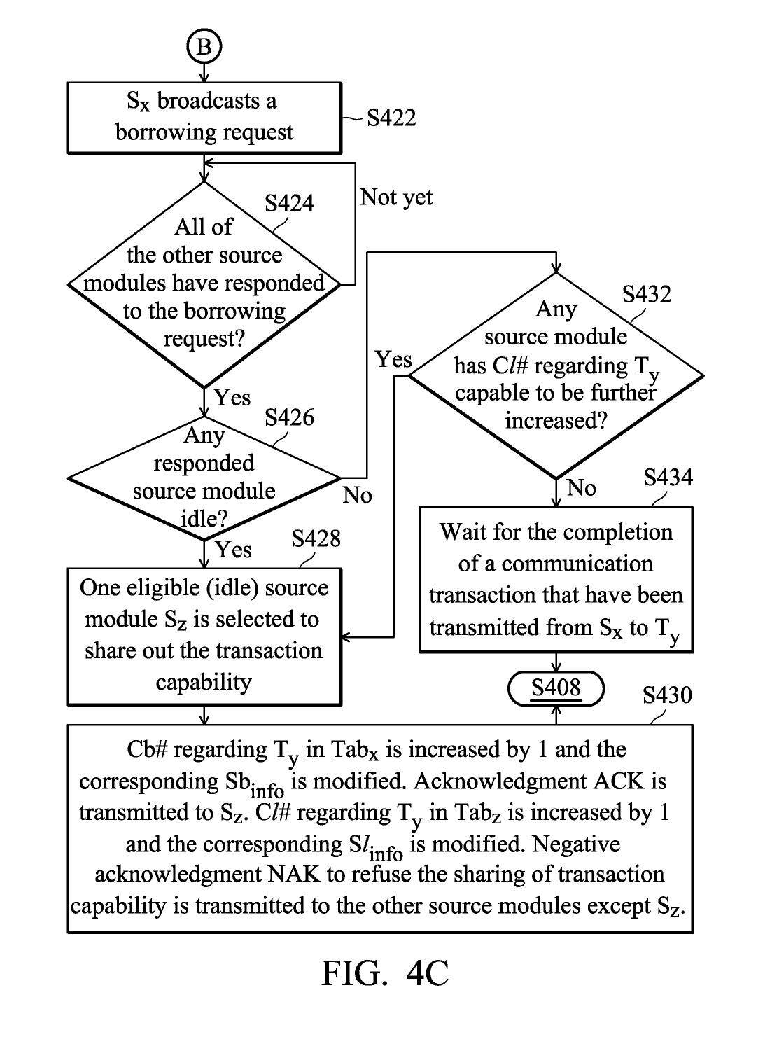

FIGS. 4A, 4B, and 4C depict a flowchart illustrating the management of the transaction capability tables Tab₀ . . . Tab₍ₘ₋₁₎ in accordance with an embodiment of the disclosure. The flowchart can be implemented by the source modules S₀ . . . S₍ₘ₋₁₎ by using hardware and code, or a state machine.

Referring to FIG. 4A, the transaction capability tables Tab₀ . . . Tab₍ₘ₋₁₎ are reset in step S402. The intrinsic transaction capability k (=r/m) is set. The borrowed transaction capability Cb#, the loan Cl# of transaction capability, the transaction capability consumption C# are all reset to 0. The borrowing information Sb_{info} and the loan information Sl_{info} are cleared. At this time, an equal value, k, is assigned as the practical transaction capability TC# for the different source modules S₀ . . . S₍ₘ₋₁₎ to transmit communication transactions to the different the destination modules T₀ . . . T₍ₘ₋₁₎.

In step S404, it detects whether a request for communication transaction occurs and the source module Sₓ and the destination module T_{y} regarding the communication transaction are recorded. With regard to this communication transaction, step S406 determines whether the practical transaction capability TC# of the source module Sₓ to the destination module T_{y} is greater than zero. If it is greater than 0, the flow proceeds to step S408, and the source module Sₓ transmits the communication transaction detected in step S404 to the queue Q_{y} of the destination module T_{y} to be temporarily stored and dynamically managed in one of the trackers. In step S408, a value representing the transaction capability consumption C# of the source module Sₓ to the destination module T_{y} is increased by one.

When it is determined in step S406 that the source module Sₓ has no transaction capability to the destination module T_{y} (the practical transaction capability TC# is 0), the flow proceeds to step S412 of FIG. 4B through the node A. In step S412, the transaction capability table TABₓ is checked, referring to the column corresponding to the destination module T_{y}, the loan Cl# of transaction capability that the source module Sₓ lends the other source modules to transact with the destination module T_{y} is obtained and a check is made as to whether the loan Cl# is greater than zero. When the loan Cl# is greater than zero, step S414 is performed to send a return request according to the loan information Sl_{info}. In an exemplary embodiment, the return request is send to the source module having the highest value of practical transaction capability TC# regarding the destination module T_{y}. In another exemplary embodiment, the return request is sent to the source module that is in the closest transmission distance. In step S416, the return of transaction capability is monitored. When the transaction capability is returned from a source module S_{z}, step S418 is performed. In a transaction capability table Tab_{z}, a value representing the borrowed transaction capability Cb# regarding the destination module T_{y} is decreased by 1 and the corresponding borrowing information Sb_{info} is modified. In the transaction capability table Tabₓ, a value representing the loan Cl# of transaction capability regarding the destination module T_{y} is decreased by 1 and the corresponding loan information Sl_{info} is modified. Then, step S408 is performed. The source module S, transmits the communication transaction to the destination module T_{y} and the value representing the transaction capability consumption C# of the source module Sₓ to the destination module T_{y} is increased by one.

When it is determined in step S412 that the source module S, has no transaction capability lent to other source modules to transact with the destination module T_{y} (the loan Cl# of transaction capability is 0), the flow proceeds through the node B to step S422 of FIG. 4C. In step S422, the source module S, broadcasts a borrowing request. In step S424, a check is made as to whether all of the other source modules have responded to the borrowing request. If yes, step S426 is performed to identify the idle source modules. In an exemplary embodiment, an idle source module does not have any communication transaction is being processed in the destination modules T₀ . . . T₍ₙ₋₁₎. In step S428, one eligible (idle) source module S_{z} is selected to share out the transaction capability. In an exemplary embodiment, the selection further depends on the transmission distance. The source module Sₓ may select the nearest source module to borrow the transaction capability. In an exemplary embodiment, the selection further depends on whether the owned transaction capability is plenty. The source module S, may select to borrow transaction capability from a source module that has plenty of transaction capability to lend other source modules, i.e. having the highest number of (k-Cl#). In step S430, the transaction capability table Tabₓ is modified. Regarding the destination module T_{y}, a value representing the borrowed transaction capability Cb# is increased by 1 and the corresponding borrowing information Sb_{info} is modified. In step S430, code for acknowledgment ACK is transmitted to the source module S_{z} to modify the transaction capability table Tab_{z}. In the transaction capability table Tab_{z}, regarding the destination module T_{y}, a value representing the loan Cl# of transaction capability is increased by 1 and the corresponding loan information Sl_{info} is modified. In step S430, code for negative acknowledgment NAK to refuse the sharing of transaction capability is transmitted to the other source modules except the source module S_{z}. Then, step S408 is performed. The source module Sₓ transmits the communication transaction to the destination module T_{y} and the value representing the transaction capability consumption C# of the source module Sₓ to the destination module T_{y} is increased by one.

When it is determined in step S426 that none of the other source modules are idle, step S432 is performed. In step S432, transaction capability tables are checked. Regarding the destination module T_{y}, the loans Cl# of transaction capability are checked. The source module S_{z} having the loan Cl# not exceeding the value k or not exceeding a threshold value 1 th (that is smaller than the value k) is selected in step S428 to lend the source module Sₓ the transaction capability. In an exemplary embodiment, the selection further depends on the transmission distance. The source module Sₓ may select the nearest source module to borrow the transaction capability. In an exemplary embodiment, the selection further depends on whether the owned transaction capability is plenty. The source module Sₓ may select to borrow transaction capability from a source module that has plenty of transaction capability to lend other source modules, i.e. having the highest number of (k-Cl#). Then, step S430 is performed for the corresponding modifications to the transaction capability tables Tabₓ and Tab_{z}. Then, step S408 is performed. The source module Sₓ sends the planned communication transaction to the destination module Ty, and the value representing the transaction capability consumption C# of the source module Sₓ to the destination module T_{y} is increased by one.

When it is determined in step S432 that no source module is qualified for sharing out the transaction capability because the checked loans Cl# of transaction capability are too high, step S434 is performed to wait for the completion of a communication transaction that have been transmitted from the source module Sₓ to the destination module T_{y} and processed in the destination module T_{y} (for example, waiting for the value representing the transaction capacity consumption C# to be decreased by 1). Then, step S408 is performed. The source module Sₓ Sends the Planned Communication Transaction to the Destination Module T_{y}, and the value representing the transaction capability consumption C# of the source module Sₓ to the destination module T_{y} is increased by one.

According to the above, the use of the all trackers of the destination module is optimized.

The number of trackers in the different queues Q0 . . . Q(n=1) (provided by the different destination modules T0 . . . T(n−1)) may be not unified as r, and may be different from each other.

In the following paragraphs, the optimized communication technology implemented on the side of destination modules is discussed.

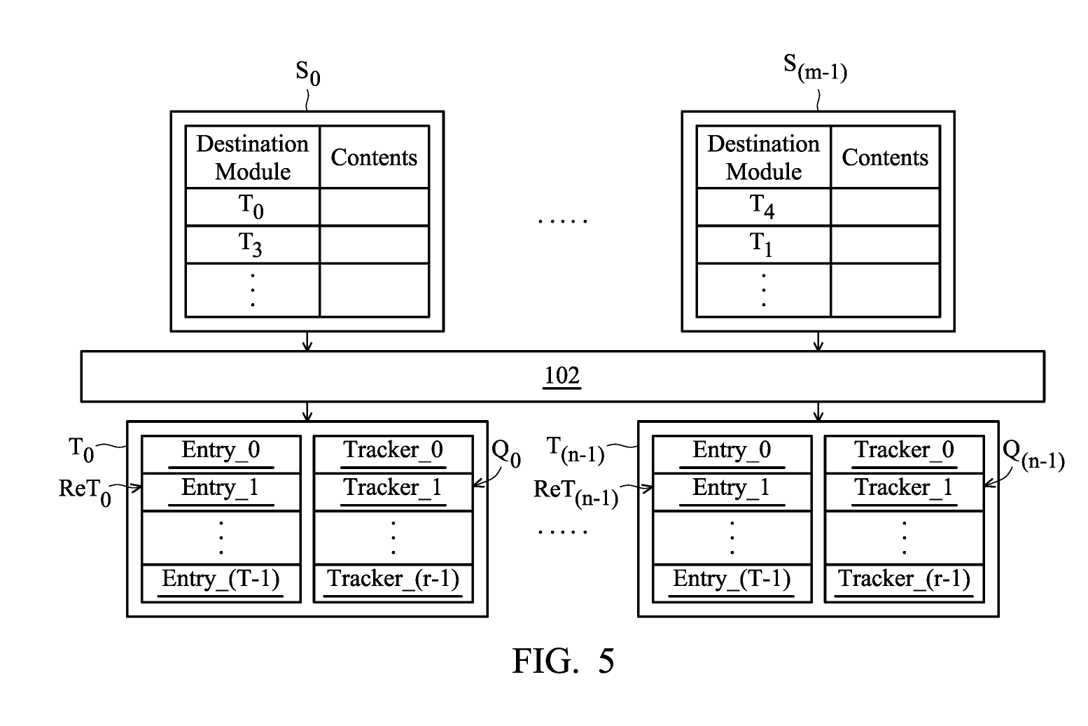

FIG. 5 illustrates the optimized communication technology implemented on the side of destination modules in accordance with an exemplary embodiment of the disclosure. The destination modules T₀ to T₍ₙ₋₁₎ use turbo queues. In addition to an aforementioned queue (referring to queues Q₀ . . . Q₍ₙ₋₁₎), a retransmission list (referring to retransmission lists ReT₀ . . . ReT₍ₙ₋₁₎) is also managed in a turbo queue. Each of the queues Q₀ to Q₍ₙ₋₁₎ contains r trackers Tracker_0 to Tracker (r−1). Each of the retransmission lists ReT₀ to ReT₍ₙ₋₁₎ contains T entries Entry_0 to Entry_(T−1). When all trackers within the same queue are occupied, the corresponding retransmission list records the identification number (ID#) for a planned communication transaction. When a tracker is released later, a retransmission request is issued according to the recorded identification number ID# and the corresponding source module retransmit the planned communication transmission that was not successfully transmitted. By managing and operating according to the retransmission lists ReT₀ to ReT₍ₙ₋₁₎, the queues Q₀ to Q₍ₙ₋₁₎ are effectively utilized.

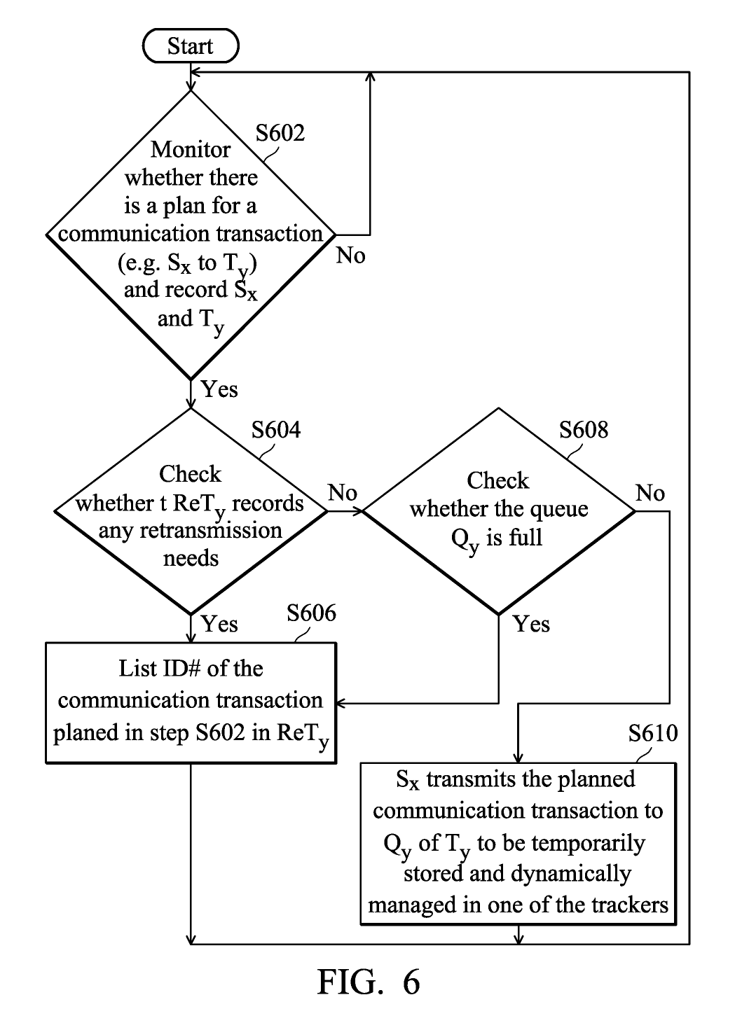

FIG. 6 is a flowchart illustrating the use of the turbo queues of FIG. 5 in accordance with an exemplary embodiment of the disclosure. The flow can be implemented in the destination modules T₀ . . . T₍ₙ₋₁₎ by hardware and code, or state machines.

In step S602, it is monitored whether there is a plan for a communication transaction, and the source module Sₓ and the destination module T_{y} regarding the planned communication transaction are recorded. For the planned communication transaction, step S604 is performed to check whether the retransmission list ReT_{y} records any retransmission needs. If yes, step S606 is performed to list the identification number ID# of the communication transaction planed in step S602 in the retransmission list ReT_{y}. Then, step S602 is performed to continue monitoring whether there are other plans for communication transactions.

When the retransmission list ReT_{y} checked in step S604 shows no communication transaction waiting to be retransmitted, step S608 is performed to check whether the queue Q_{y} is full. When the queue Q_{y} is full, step S606 is performed and the identification number ID# of the communication transaction planed in step S602 is listed in the retransmission list ReT_{y}. When the queue Q_{y} has any empty tracker, the flow proceeds to step S610. The source module Sₓ transmits the planned communication transaction to the queue Q_{y} of the destination module T_{y} to be temporarily stored and dynamically managed in one of the trackers. Then, step S602 is performed to continue monitoring whether there are other plans of communication transactions.

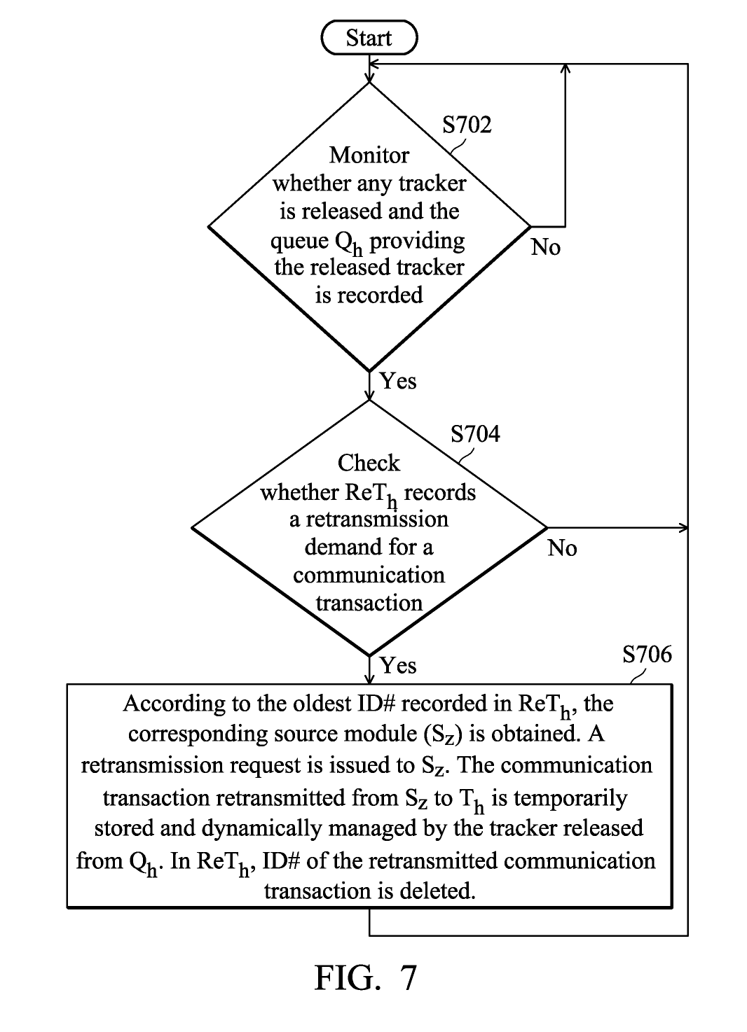

FIG. 7 is another flowchart illustrating the use of the turbo queues of FIG. 5 in accordance with an exemplary embodiment of the disclosure. The flow can be implemented in the destination modules T₀ . . . T₍ₙ₋₁₎ by hardware and code, or state machines.

In step S702, it is monitored whether any tracker is released and the queue Qₕ providing the released tracker is recorded. For the released tracker, step S704 is performed to check whether the retransmission list ReTₕ records a retransmission demand for a communication transaction. If yes, step S706 is performed. According to the oldest identification number ID# recorded in the retransmission list ReTₕ, the corresponding source module S_{z} is obtained. A retransmission request is issued and the source module S_{z} retransmits the communication transaction (with the identification number ID#) to the destination module Tₕ to be temporarily stored and dynamically managed by the tracker released from the queue Qₕ. In the retransmission list ReTₕ, the identification number ID# of the retransmitted communication transaction is deleted. Then, step S702 is performed to continue monitoring whether any tracker of the queues Q₀ . . . Q₍ₙ₋₁₎ is released. When it is determined in step S704 that the retransmission list ReTₕ does not record any retransmission demand for any communication transaction, the flow may also go back to step S702 to monitor whether any tracker is released.

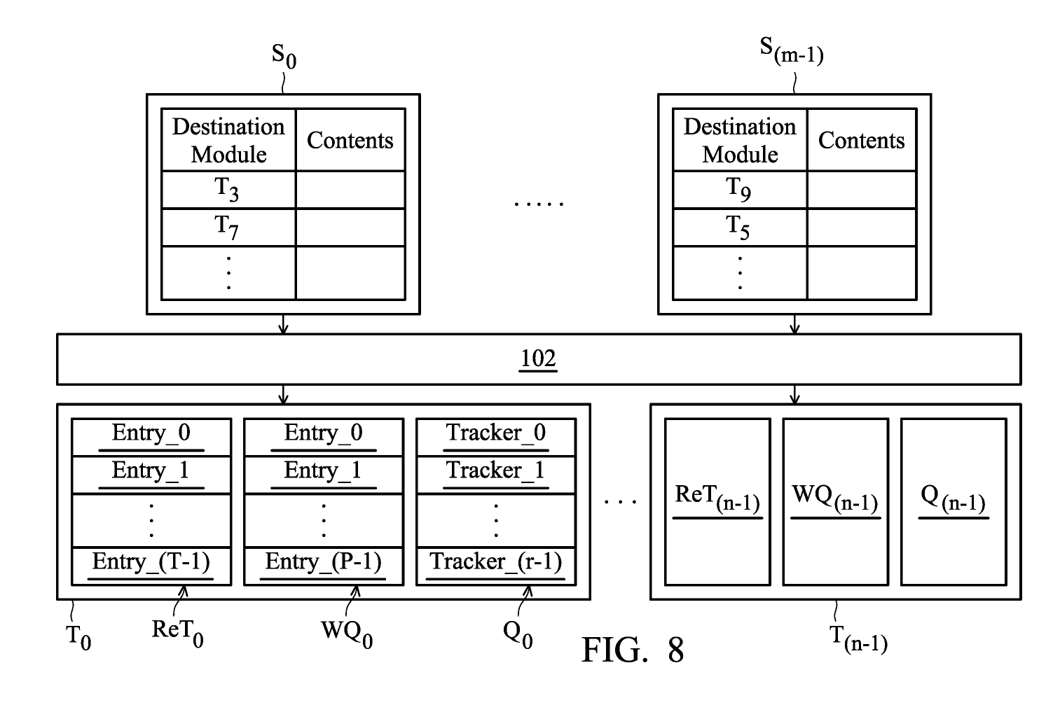

FIG. 8 illustrates an optimized communication technology implemented on the side of destination modules in accordance with another exemplary embodiment of the disclosure. The destination modules T₀ to T₍ₙ₋₁₎ each contains a turbo queue which is an upgraded version of the turbo queues mentioned in FIG. 5. In addition to the queues Q0 . . . Q₍ₙ₋₁₎ and the retransmission lists ReT₀ . . . ReT₍ₙ₋₁₎, the destination modules T₀ . . . T₍ₙ₋₁₎ further manages waiting queues WQ₀ . . . WQ₍ₙ₋₁₎.

Each of the queues Q₀ . . . Q₍ₙ₋₁₎ has r trackers Tracker_0 to Tracker_(r−1) for temporarily storage and dynamic management of communication transactions transmitted from the source modules S₀ . . . S₍ₘ₋₁₎ through the on-chip interconnection network 102. One tracker is provided to correspond to one communication transaction. Each tracker has a state machine that dynamically manages the communication transaction temporarily stored therein. Each of the waiting queues WQ₀ . . . WQ₍ₙ₋₁₎ has P entries Entry_0 to Entry_(P−1). When all trackers of one queue are occupied, the corresponding waiting queue uses one column to record the currently-received communication transaction. When one tracker is released, a communication transaction temporarily stored in the corresponding waiting queue is moved to the released tracker. The waiting queues WQ₀ . . . WQ₍ₙ₋₁₎ generally do not include any state machine and are not responsible for the management of the temporarily stored communication transactions. Therefore, the size and power consumption of the queues WQ₀ to WQ₍ₙ₋₁₎ are much smaller than the queues Q₀ to Q₍ₙ₋₁₎. Each of the retransmission lists ReT₀ . . . ReT₍ₙ₋₁₎ has T entries Entry_0, Entry_1 . . . Entry (T−1). When all entries of one waiting queue are occupied, the corresponding retransmission list records the identification number ID# of the planed communication transaction. When an entry of the waiting queue is released later, a retransmitting request is sent according to the recorded identification number ID# and thereby the corresponding source module retransmits the communication transaction that was not successfully transmitted before. The retransmitted communication transaction is stored in the waiting queue waiting to be moved to a released tracker of the corresponding queue. According to the design of FIG. 8, a tracker released from a queue is filled in time by moving a communication transaction waited in the corresponding waiting queue to the released tracked. No retransmission delay is required. In comparison with the design of FIG. 5, the design of FIG. 8 utilizes the queues Q₀ to Q₍ₙ₋₁₎ more effectively.

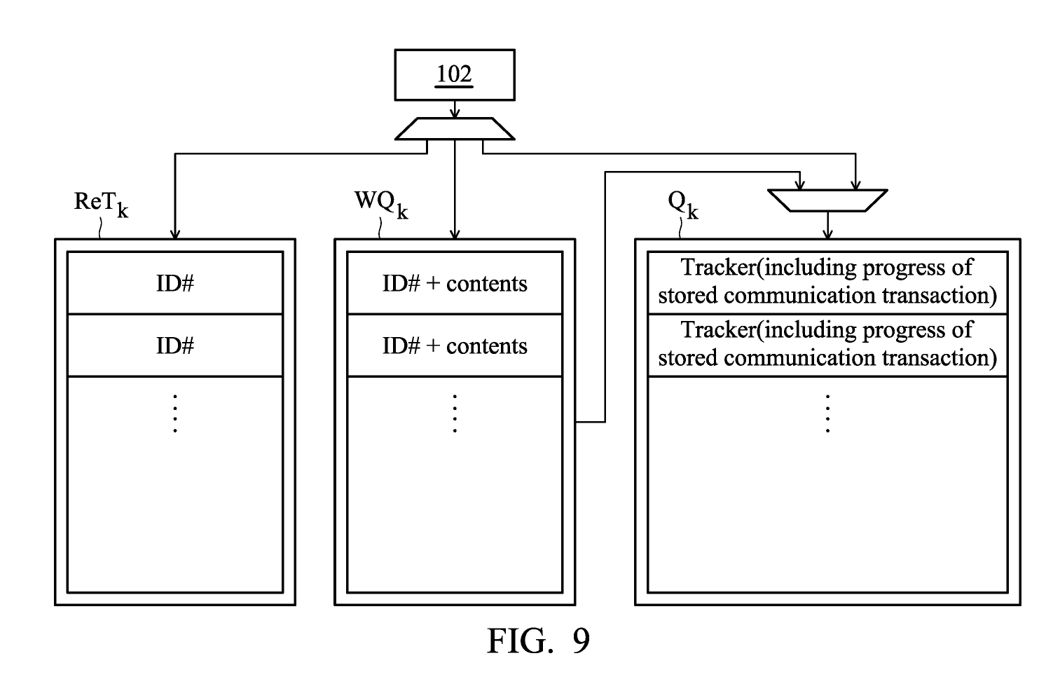

FIG. 9 illustrates how communication transactions transmitted to a destination module Tₖ through the on-chip interconnection network 102 is filled in a turbo queue taught in FIG. 8. A queue Qₖ has several trackers. In each tracker, the progress of the temporarily stored communication transaction is monitored. For example, a state machine in each tracker may show the progress of the monitored communication transaction. The waiting queue WQₖ is not responsible for the dynamic management of the communication transaction temporarily stored therein. In each entry of the waiting queue WQₖ, an identification number ID# and corresponding transaction contents are recorded. The retransmission list ReTₖ is smaller than the waiting queue WQₖ in size, storing identification numbers ID# but not storing the transaction contents. The trackers of the queue Qₖ may store contents of communication transactions transmitted from source modules through the on-chip interconnection network 102 or store transaction contents obtained from the waiting queue WQₖ. The waiting queue WQk may store transaction contents retransmitted from source modules through the on-chip interconnection network 102 or transaction contents transmitted from source modules through the on-chip interconnection network 102 the first time. The identification numbers ID# recorded in the retransmission list ReTₖ are obtained from communication transaction which failed to be successfully received.

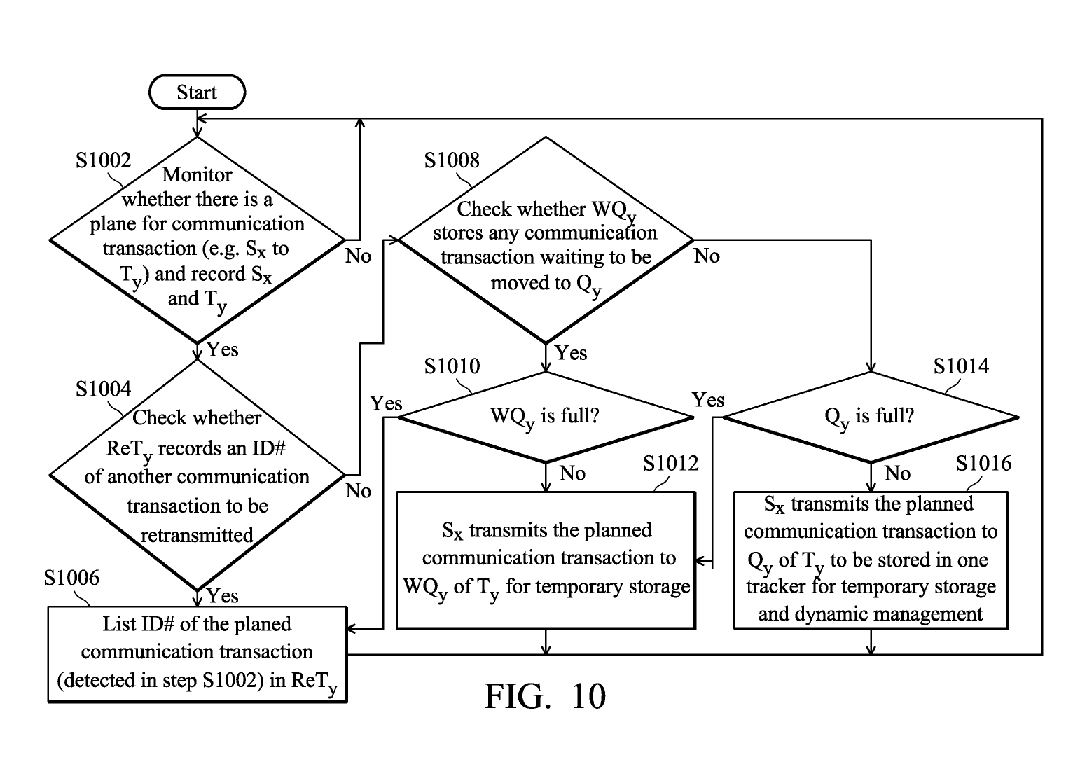

FIG. 10 is a flowchart illustrating the use of the turbo queues of FIG. 8 in accordance with an exemplary embodiment of the disclosure. The flow can be implemented in the destination modules T₀ . . . T₍ₙ₋₁₎ by hardware and code, or state machines.

In step S1002, it is monitored whether there is a plane for communication transaction, and it is recorded that the communication transaction is issued by the source module Sₓ to the destination module T_{y}. For the planed communication transaction, step S1004 is performed to check whether the retransmission list ReT_{y} records an identification number ID# of another communication transaction to be retransmitted. If yes, step S1006 lists the identification number ID# of the planed communication transaction (detected in step S1002) in the retransmission list ReT_{y}. Then, the flow may return to step S1002 to continue monitoring whether there are other plans of for communication transactions.

If it is determined in step S1004 that the retransmission list ReT_{y} does not mention any communication transaction to be retransmitted, step S1008 is performed to check whether the waiting queue WQ_{y} stores any communication transaction waiting to be moved to the queue Q_{y}. If so, step S1010 is performed to check if the waiting queue WQ_{y} is full. If it is full, the flow proceeds to step S1006, and the identification number ID# of the planned communication transaction (detected in step S1002) is added to the retransmission list ReT_{y}. If there is an empty entry in the waiting queue WQ_{y}, the flow proceeds to step S1012, and the source module Sₓ Transmits the Planned Communication Transaction to the Waiting Queue WQ_{y} of the destination module T_{y} for temporary storage. Then, the flow may return to step S1002 to continue monitoring whether there are other plans for communication transactions.

When it is determined in step S1008 that the waiting queue WQ_{y} does not contain any communication transaction waiting to be moved to the queue Q_{y}, step S1014 checks if the queue Q_{y} is full. If the queue Q_{y} is full, the flow proceeds to step S1012, and the source module S, transmits the planned communication transaction to the waiting queue WQ_{y} of the destination module T_{y} for temporary storage. If the queue Q_{y} has an empty tracker for the planned communication transaction, the flow proceeds to step S1016. The source module Sₓ transmits the planned communication transaction to queue Q_{y} of destination module T_{y} to be stored in one tracker for temporary storage and dynamic management. Then, the flow may return to step S1002 to continue monitoring whether there are other plans for communication transactions.

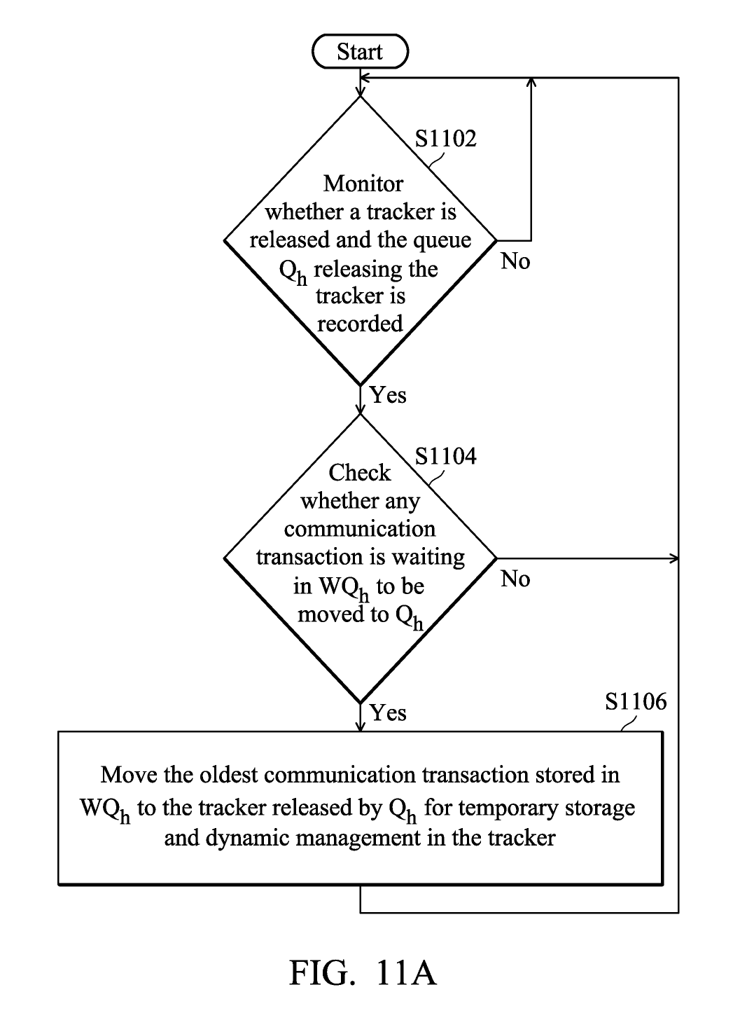

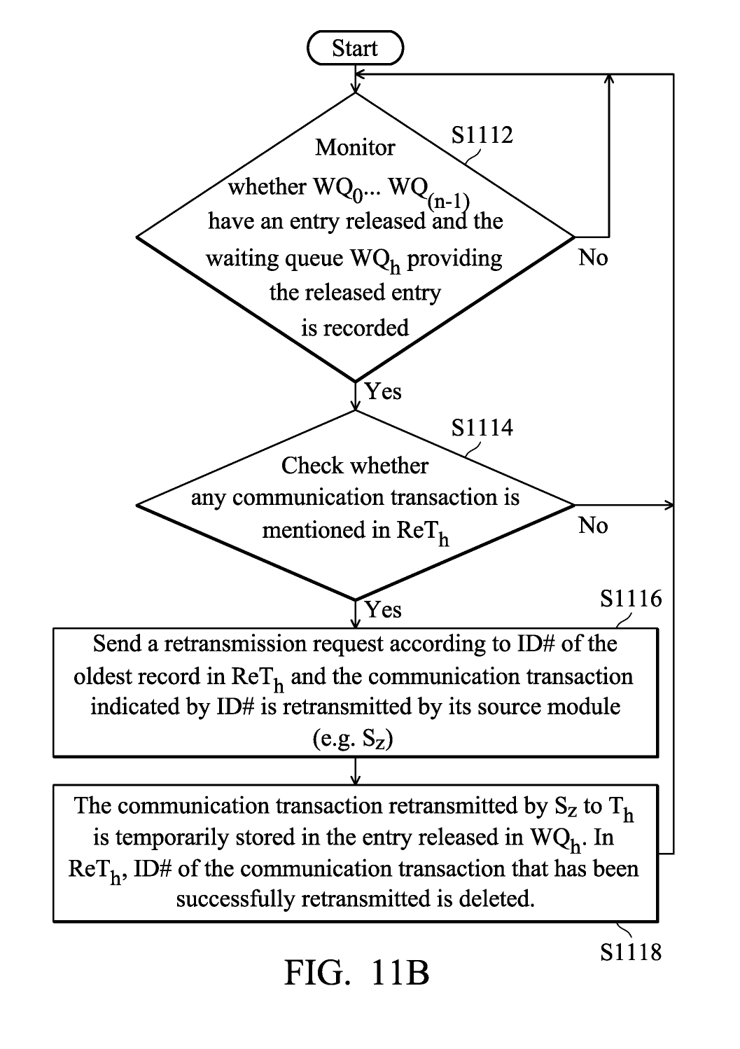

FIG. 11A is a flowchart illustrating the use of the turbo queues of FIG. 8 in accordance with an embodiment of the disclosure. The flow can be implemented in the destination modules T₀ . . . T₍ₙ₋₁₎ by hardware and code, or state machines.

Step S1102 monitors whether a tracker is released and the queue Qₕ releasing the tracker is recorded. For the released tracker of the queue Qₕ, step S1104 is performed to check whether any communication transaction is waiting in the waiting queue WQₕ to be moved to the queue Qₕ. If yes, step S1106 moves the oldest communication transaction stored in the waiting queue WQₕ to the tracker released by the queue Qₕ for temporary storage and dynamic management in the tracker. Then, the flow may return to step S1102 to continue monitoring whether any tracker in the queues Q₀ . . . Q₍ₙ₋₁₎ is released. When it is determined in step S1104 that there is no communication transaction in the waiting queue WQₕ waiting to be moved to the queue Qₕ, the flow returns to step S1102 to continue monitoring whether any tracker of the queues Q₀ . . . Q₍ₙ₋₁₎ is released.

FIG. 11B is another flowchart illustrating the use of the turbo queues of FIG. 8 in accordance with an embodiment of the disclosure. The method can be implemented in the destination modules T₀ . . . T₍ₙ₋₁₎ by hardware and code, or state machines.

Step S1112 monitors whether the waiting queues WQ₀ . . . WQ₍ₙ₋₁₎ have an entry released (e.g., moving a communication transaction from a waiting queue to a tracker in step S1106 of FIG. 11A) and the waiting queue WQₕ providing the released entry is recorded. For the entry released from the waiting queue WQₕ, step S1114 is performed to check whether any communication transaction is mentioned in the retransmission list ReTₕ. If yes, step S1116 is performed to send a retransmission request according to the identification number ID# of the oldest record in the retransmission list ReTₕ and the communication transaction indicated by the identification number ID# is retransmitted by its source module (e.g. S_{z}). In step S1118, the communication transaction retransmitted by the source module S_{z} to the destination module Tₕ is temporarily stored in the entry released in the waiting queue WQₕ. In the retransmission list ReTₕ, the identification number ID# of the communication transaction that has been successfully retransmitted is deleted. Then, the flow can go back to step S1112 to monitor whether the waiting queues WQ₀ . . . WQ₍ₙ₋₁₎ has another entry being released. When it is determined in step S1114 that the retransmission list ReTₕ does not list any identification number ID#, the flow may also return to step S1112 to continue monitoring whether the waiting queues WQ₀ . . . WQ₍ₒ₋₁₎ has another entry being released.

The monitoring step S1102 of FIG. 11A for the queues Q₀ to Q₍ₙ₋₁₎ and the monitoring step S1112 of FIG. 11B for the waiting queues WQ₀ to WQ₍ₙ₋₁₎ may be performed in parallel.

As the aforementioned discussion, the turbo queues provided in the destination modules T₀ . . . T₍ₙ₋₁₎ result in significant improvements. Other variations are possible. The number of trackers in each of the queues Q₀ . . . Q₍ₙ₋₁₎ of the different destination modules T₀ . . . T₍ₙ₋₁₎ is not limited to r. The different queues Q₀ . . . Q₍ₙ₋₁₎ may have different number of trackers. The different retransmission lists ReT₀ . . . ReT₍ₙ₋₁₎ of the different destination modules T₀ . . . T₍ₙ₋₁₎ may be different in size. The different waiting queues WQ₀ . . . WQ₍ₙ₋₁₎ of the different destination modules T₀ . . . T₍ₙ₋₁₎ may have different number of entries.

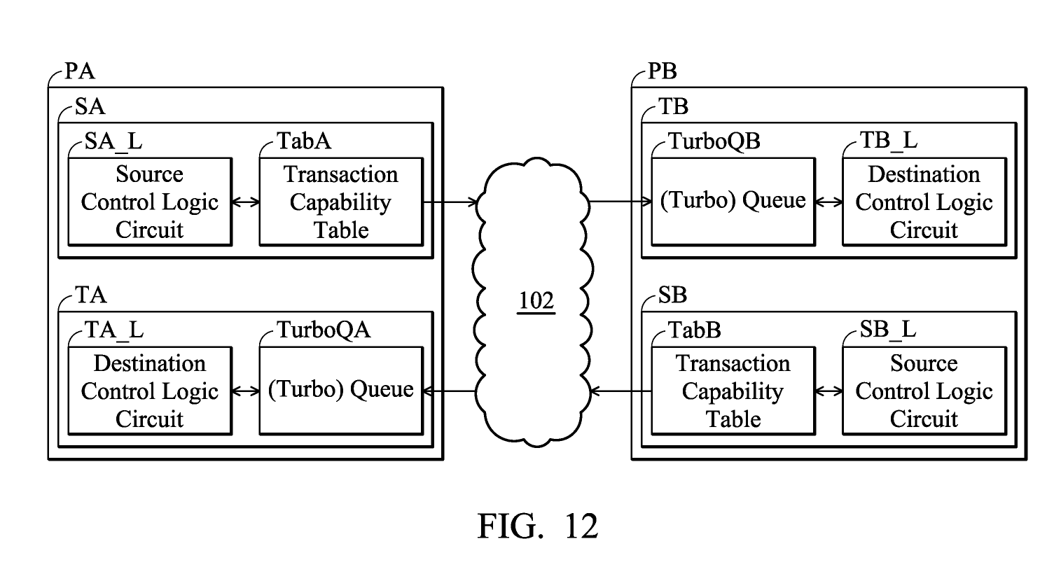

FIG. 12 is a block diagram depicting communication optimization in accordance with an exemplary embodiment of the disclosure. The devices/functional blocks (or IPs or circuits) PA and PB may perform bidirectional communication transactions through the on-chip interconnection network 102. The functional block PA includes a source module SA and a destination module TA. The functional block PB includes a source module SB and a destination module TB. The source modules SA and SB have transaction capability tables TabA and TabB (referring to FIG. 3) managed thereon and source control logic circuits SA_L and SB_L (referring to FIGS. 4A to 4C, which can be implemented by hardware or by jointly using hardware and software). The destination modules TA and TB have (turbo) queues TurboQA and TurboQB (referring to FIG. 5, FIG. 8 or FIG. 9), and destination control logic circuits TA_L and TB_L (referring to FIGS. 6, 7, 10, 11A and 11B, which can be implemented by hardware or by jointly using hardware and software). Referring to FIG. 1, the functional blocks PA and PB may be the CPU, image processor (GPU), input/output controller (I/O controller), cache L2/LLC controller, memory controller, and so on. The technology of the disclosure is not limited to involving an on-chip interconnection network 102 within an SoC. Any signal transmitting and receiving may use the aforementioned techniques.

Other techniques that use the above concepts in signal transmitting and receiving are within the scope of the disclosure. Based on the above contents, the present invention further relates to a communication method.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication controller, comprising:
a transaction capability table, recording a first value representing practical transaction capability of a source module for transmitting a communication transaction to a destination module, wherein exchange of transaction capability, regarding the destination module, between the source module and at least one neighboring source module is taken into account in the first value; and
a source control logic circuit, managing the transaction capability table and controlling the source module to transmit a communication transaction to the destination module based on the first value recorded in the transaction capability table.

2. The communication controller as claimed in claim 1, wherein:
the transaction capability table further records a second value representing borrowed transaction capability that the source module borrows from the at least one neighboring source module for transmitting a communication transaction to the destination module; and
the transaction capability table further records a third value representing a loan of transaction capability that the source module lends to the at least one neighboring source module to transmit a communication transaction to the destination module.

3. The communication controller as claimed in claim 2, wherein:
the transaction capability table further records borrowing information, wherein the borrowing information lists neighboring source modules from which the source module receives the borrowed transaction capability; and
the transaction capability table further records loan information, wherein the loan information lists neighboring source modules that receive the loan of transaction capability.

4. The communication controller as claimed in claim 3, wherein:
the transaction capability table further records a fourth value representing intrinsic transaction capability of the source module for transmitting a communication transaction to the destination module;
the first value is the fourth value plus the second value minus the third value and further minus a fifth value, the fifth value representing transaction capability consumption of the source module regarding the destination module; and
the transaction capability consumption shows how many communication transactions have been transmitted from the source module to the destination module and are being processed in the destination module.

5. The communication controller as claimed in claim 4, wherein:
the source control logic circuit ensures that the third value does not exceed the fourth value.

6. The communication controller as claimed in claim 5, wherein:
when the first value is zero and the third value is not zero, the source control logic circuit requests a return of transaction capability according to the loan information.

7. The communication controller as claimed in claim 6, wherein:
when the first value is zero and the third value is also zero, the source control logic circuit broadcasts to the at least one neighboring source module to borrow transaction capability.

8. The communication controller as claimed in claim 7, where:
the destination module has a queue containing r trackers for temporary storage and dynamic management of r communication transactions, wherein r is a number; and
the fourth value is an amount of trackers allocated from the r trackers to the source module.

9. The communication controller as claimed in claim 8, wherein:
the fifth value represents an amount of trackers, among the r trackers, which are occupied by communication transactions transmitted from the source module.

10. The communication controller as claimed in claim 9, wherein:
the fourth value is r/m, wherein m is an amount of possible source modules regarding the destination module.

11. A system on a chip, comprising:
a plurality of source modules; and
at least one destination module,
wherein each source module has a communication controller as claimed in claim 1 to transmit at least one communication transaction to the at least one destination module.

12. A communication method, comprising:
using a transaction capability table to record a first value representing practical transaction capability of a source module for transmitting a communication transaction to a destination module, wherein exchange of transaction capability regarding the destination module between the source module and at least one neighboring source module is taken into account in the first value; and
managing the transaction capability table and controlling the source module to transmit a communication transaction to the destination module based on the first value recorded in the transaction capability table.

13. The communication method as claimed in claim 12, further comprising:
using the transaction capability table to record a second value representing borrowed transaction capability that the source module borrows from the at least one neighboring source module for transmitting a communication transaction to the destination module; and
using the transaction capability table to record a third value representing a loan of transaction capability that the source module lends to the at least one neighboring source module to transmit a communication transaction to the destination module.

14. The communication method as claimed in claim 13, further comprising:
using the transaction capability table to record borrowing information, wherein the borrowing information lists neighboring source modules from which the source module receives the borrowed transaction capability; and
using the transaction capability table to record loan information, wherein the loan information lists neighboring source modules that receive the loan of transaction capability.

15. The communication method as claimed in claim 14, further comprising:
using the transaction capability table to record a fourth value representing intrinsic transaction capability of the source module for transmitting a communication transaction to the destination module,
wherein:
the first value is the fourth value plus the second value minus the third value and further minus a fifth value, the fifth value representing transaction capability consumption of the source module regarding the destination module; and
the transaction capability consumption shows how many communication transactions have been transmitted from the source module to the destination module and are being processed in the destination module.

16. The communication method as claimed in claim 15, further comprising:
ensuring that the third value does not exceed the fourth value.

17. The communication method as claimed in claim 16, further comprising:
when the first value is zero and the third value is not zero, requesting a return of transaction capability according to the loan information.

18. The communication method as claimed in claim 17, further comprising:
when the first value is zero and the third value is also zero, the source control logic circuit broadcasts to the at least one neighboring source module to borrow transaction capability.

19. The communication method as claimed in claim 18, wherein:
the destination module has a queue containing r trackers for temporary storage and dynamic management of r communication transactions, where r is a number; and
the fourth value is an amount of trackers allocated from the r trackers to the source module.

20. The communication method as claimed in claim 19, wherein:
the fifth value represents an amount of trackers, among the r trackers, which are occupied by communication transactions transmitted from the source module.

21. The communication method as claimed in claim 20, wherein:
the fourth value is r/m, wherein m is an amount of possible source modules regarding the destination module.
